(19) United States
(12) Patent Application Publication
(10) Pub. No.: US 2025/0055749 A1
(43) Pub. Date: Feb. 13, 2025

(54) METHOD AND APPARATUS FOR MANAGING A NON-TERRESTRIAL NETWORK IN A WIRELESS COMMUNICATION SYSTEM

(71) Applicant: Samsung Electronics Co., Ltd., Gyeonggi-do (KR)

(72) Inventors: Ashutosh KAUSHIK, Bangalore (IN); Deepanshu Gautam, Bangalore (IN)

(21) Appl. No.: 18/799,042

(22) Filed: Aug. 9, 2024

(30) Foreign Application Priority Data
Aug. 10, 2023 (IN) 202341053812
Jul. 26, 2024 (IN) 202341053812

(51) Int. Cl. H04L 41/0233; H04B 7/185

(52) U.S. Cl. CPC H04L 41/0233; H04B 7/18519

(57) ABSTRACT

The disclosure relates to a 5G or 6G communication system for supporting a higher data transmission rate. A system and a method are provided for NTN management. A method performed by an MnS producer in a wireless communication system is provided. The method includes receiving, from an MnS consumer, a request for creating an MOI of an AMF IOC, wherein the AMF IOC includes a first attribute for a satellite coverage information; and transmitting, to the MnS consumer, a response of a creation of the MOI.

### CROSS-REFERENCE TO RELATED APPLICATION(S)

This application is based on and claims priority under 35 U.S.C. § 119 to Indian Provisional Patent Application No. 202341053812, which was filed in the Indian Patent Office on Aug. 10, 2023, and to Indian Patent Application number 202341053812, which was filed in the Indian Patent Office on Jul. 26, 2024, the entire content of each of which is incorporated herein by reference.

### BACKGROUND

### 1. Field

The disclosure generally relates to a non-terrestrial network (NTN) and, more particularly, to a method and a system for NTN management.

### 2. Description of Related Art

5^{th} generation (5G) mobile communication technologies define broad frequency bands such that high transmission rates and new services are possible, and can be implemented in “sub 6 gigahertz (GHz)” bands such as 3.5 GHz, and in “above 6 GHz” bands, which may be referred to as mmWave, including 28 GHz and 39 GHz.

In addition, it has been considered to implement 6^{th} generation (6G) mobile communication technologies (e.g., referred to as beyond 5G systems) in terahertz (THz) bands (e.g., 95 GHz to 3 THz bands) in order to accomplish transmission rates fifty times faster than 5G mobile communication technologies and ultra-low latencies one-tenth of 5G mobile communication technologies.

Since the initial development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple-input, multiple-output (MIMO) for mitigating radio-wave path loss and increasing radio-wave transmission distances in mmWave, supporting numerologies (e.g., operating multiple subcarrier spacings) for efficiently utilizing mm Wave resources and dynamic operation of slot formats, initial access technologies for supporting multi-beam transmission and broadbands, definition and operation of a bandwidth part (BWP), new channel coding methods such as a low density parity check (LDPC) code for a relatively large data transmission and a polar code for highly reliable transmission of control information, layer 2 (L2) pre-processing, and network slicing for providing a dedicated network specialized to a specific service.

There are also ongoing discussions regarding improvement and performance enhancement of initial 5G mobile communication technologies in view of services to be supported by newer 5G mobile communication technologies, e.g., physical layer standardization regarding technologies such as vehicle-to-everything V2X ( ) for aiding driving determination by autonomous vehicles based on information regarding positions and states of vehicles transmitted by the vehicles and for enhancing user convenience, new radio (NR)-unlicensed (U) aimed at system operations conforming to various regulation-related requirements in unlicensed bands, NR user equipment (UE) power saving, an NTN, which is UE-satellite direct communication for providing coverage in an area in which communication with terrestrial networks is unavailable, and positioning.

There is also ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR).

There is also ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, the number of devices that will be connected to communication networks is expected to exponential increase, and it is accordingly expected that enhanced functions and performances of 5G mobile communication systems and integrated operations of connected devices will be necessary. To this end, new research is scheduled in connection with extended Reality (XR) for efficiently supporting augmented reality (AR), virtual reality (VR), mixed reality (MR), etc., 5G performance improvement and complexity reduction by utilizing artificial intelligence (AI) and machine learning (ML), AI service support, metaverse service support, and drone communication.

Furthermore, such development of 5G mobile communication systems will serve as a basis for developing new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of THz band signals, high-dimensional space multiplexing technology using orbital angular momentum, and reconfigurable intelligent surface (RIS), as well as full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

NTNs provide non-terrestrial NR access to a UE through a satellite and an NTN gateway. Providing NR access to the UE involves depicting a service link between the satellite and the UE, and a feeder link between the NTN gateway and the satellite. The satellite transparently forwards the radio protocol received via the service link from the UE to the NTN gateway via the feeder link and vice-versa. Further, this connectivity is supported by the satellite. The NTN gateway may serve multiple satellites, and the satellite may be served by multiple NTN gateways. The satellites may be served with three types of service links such as an earth-fixed service, a quasi-Earth-fixed service and an earth-moving service.

The satellite access has several characteristics such as the satellite can be stationary with respect to earth movements, or the satellite can be changing with respect to the earth movement. Further, the satellite can be placed in low, medium, or a geo-stationary earth orbit. Therefore, satellite access coverage may be prone to un-availability at times in some locations due to non-terrestrial nature. Thus, there is a need for provisioning satellite coverage information to the network.

Further, a core network should know accurate UE location for various purposes like paging optimization, sending public warning system (PWS) messages, mobility management, etc. However, for an Earth moving satellite, a radio cell identifier (ID) cannot be used to get an accurate UE location, since the radio cell ID may be moving together with the satellite. Hence, there is also a need for provisioning accurate UE location for the core network.

### SUMMARY

Accordingly, an aspect of the disclosure is to provide a method and a system for NTN management for provisioning satellite coverage information to the NTN.

Another aspect of the disclosure is to provide a method and a system for NTN management for provisioning accurate UE location for a core network.

In accordance with an aspect of the disclosure, a management service (MnS) producer is provided for use in a wireless communication system. The MnS producer includes a transceiver; and a controller coupled with the transceiver, and configured to receive, from an MnS consumer, a request for creating a managed object instance (MOI) of an access and mobility management function (AMF) information object class (IOC), wherein the AMF IOC includes a first attribute for a satellite coverage information, and transmit, to the MnS consumer, a response of a creation of the MOI.

In accordance with another aspect of the disclosure, an MnS consumer is provided for use in a wireless communication system. The MnS consumer includes a transceiver; and a controller coupled with the transceiver, and configured to transmit, to an MnS producer, a request for creating an MOI of an AMF IOC, wherein the AMF IOC includes a first attribute for a satellite coverage information, and receive, from the MnS producer, a response of a creation of the MOI.

In accordance with another aspect of the disclosure, a method performed by an MnS producer in a wireless communication system is provided. The method includes receiving, from an MnS consumer, a request for creating an MOI of an AMF IOC, wherein the AMF IOC includes a first attribute for a satellite coverage information; and transmitting, to the MnS consumer, a response of a creation of the MOI.

In accordance with another aspect of the disclosure, a method performed by an MnS consumer in a wireless communication system is provided. The method includes transmitting, to an MnS producer, a request for creating an MOI of an AMF IOC, wherein the AMF IOC includes a first attribute for a satellite coverage information; and receiving, from the MnS producer, a response of a creation of the MOI.

### BRIEF DESCRIPTION OF DRAWINGS

The above and other objects, features, aspects, and advantages of certain embodiment of the disclosure will be more apparent from the following detailed description taken in conjunction with the accompanying drawings, in which:

FIG. 1 illustrates an environment for NTN management, according to an embodiment;

FIG. 2 illustrates a provisioning MnS producer for providing satellite access coverage information in an NTN, according to an embodiment;

FIG. 3 illustrates a provisioning MnS producer for providing NTN NR cell identity mapping information for geographical locations in an NTN, according to an embodiment;

FIG. 4 is a signal flow diagram illustrating a method for providing satellite access coverage information in an NTN, according to an embodiment;

FIG. 5 is a signal flow diagram illustrating a method for providing NTN NR cell identity mapping information for geographical locations in an NTN, according to an embodiment;

FIG. 6A is a flow chart illustrating a method for providing satellite access coverage information in an NTN, according to an embodiment;

FIG. 6B is a flow chart illustrating a method for providing modified satellite access coverage information in an NTN, according to an embodiment;

FIG. 7A is a flow chart illustrating a method for providing NTN NR cell identity mapping information for geographical locations in an NTN, according to an embodiment;

FIG. 7B is a flow chart illustrating a method for providing modified NTN NR cell identity mapping information for geographical locations in an NTN, according to an embodiment;

FIG. 8 illustrates a system for NTN management, according to an embodiment;

FIG. 9 illustrates a UE or a base station according to an embodiment; and

FIG. 10 illustrates a network entity according to an embodiment.

### DETAILED DESCRIPTION

The embodiments herein and the various features and advantageous details thereof are explained more fully with reference to the non-limiting embodiments that are illustrated in the accompanying drawings and detailed in the following description.

Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. The terminology used herein is for the purposes of describing particular embodiments only and is not intended to be limiting.

Herein, the word “exemplary” may be used as “serving as an example, instance, or illustration.” As such, any embodiment or implementation of the present subject matter described herein as “exemplary” is not necessarily to be construed as preferred or advantageous over other embodiments.

While the disclosure may be susceptible to various modifications and alternative forms, specific embodiments thereof have been shown by way of example in the drawings and will be described in detail below. It However, these embodiments are not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a setup, device or method that comprises a list of components or operations does not include only those components or operations but may include other components or operations not expressly listed or inherent to such setup or device or method. In other words, one or more elements in a system or apparatus proceeded by “comprises . . . a” does not, without more constraints, preclude the existence of other elements or additional elements in the system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Generally, an NTN provides non-terrestrial NR access to a UE through an NTN payload and an NTN gateway. This may involve establishing a service link between the NTN payload and a UE, and a feeder link between the NTN gateway and the NTN payload. The NTN payload transparently forwards the radio protocol received via the service link from the UE to the NTN gateway via the feeder link and vice-versa. Further, this connectivity is supported by the NTN payload. The NTN gateway may serve multiple NTN payloads, and an NTN payload may be served by multiple NTN gateways.

Three types of service links that are supported by the NTN payload include an Earth-fixed service, a quasi-Earth-fixed service, and an earth-moving service.

The earth-fixed service is provisioned by beam(s) continuously covering the same geographical areas all the time (e.g., geosynchronous orbit (GSO) satellites). The quasi-Earth-fixed service is provisioned by beam(s) covering one geographic area for a limited period and a different geographic area during another period (e.g., non-GSO (NGSO) satellites generating steerable beams). The earth-moving service is provisioned by beam(s) whose coverage area slides over the Earth's surface (e.g., NGSO satellites generating fixed or non-steerable beams). With NGSO satellites, a g-NodeB (gNB) can provide either a quasi-Earth-fixed service link or an Earth-moving service link, while a gNB operating with a GSO satellite can provide an Earth fixed service link.

Currently, a 5G system includes a 5G access network (AN), a 5G core network, and a UE. The 5G system provides support for a variety of different communication services, different traffic loads, and different end user communities. For example, the communication services using network slicing may include V2X services. The 5G system aims to enhance its capability to meet key performance indicators (KPIs) that emerging V2X applications will require. For these advanced applications, the requirements, such as data rate, reliability, latency, communication range, and speed, will be more stringent.

5G seamless eMBB, which is considered to be one of the technologies to enable network slicing wherein fixed mobile convergence (FMC), which includes wireless-to-the-everything (WTTx) and fibre-to-the-everything (FTTx), provides native support for network slicing. For optimization and resource efficiency, the 5G system selects the most appropriate 3^{rd} generation partnership project (3GPP) or non-3GPP access technology for a communication service, thereby potentially allowing multiple access technologies to be used simultaneously for one or more services active on the UE.

Support for massive Internet of things (mIoT) also brings many new requirements in addition to mobile broadband (MBB) enhancements. Communication services with massive IoT connections such as smart households, smart grids, smart agriculture, and smart meters will require the support of a large number and high density IoT devices to be efficient and cost effective.

Operators use one or more network slice instances to provide these communication services which require similar network characteristics to different vertical industries. 3GPP TS 28.530 and 28.531 define the management of network slice in 5G networks, and also define the concept of communication services, which are provided using one or multiple network slices. A network slice instance (NSI) supports multiple communication service instances. Similarly, the communication service instances utilize multiple NSIs. A slice serves users in a particular geographical location known as slice coverage area.

Satellite access has several characteristics such that a satellite can be stationary with respect to Earth movements, or it can change with respect to Earth movement. Further, a satellite can be placed in low, medium, or a geo-stationary earth orbit. Therefore, satellite access coverage may be prone to un-availability at times in some locations due to non-terrestrial nature. Once the satellite access is decided, it should be provisioned in the network at several entities before being operational. However, in existing network configuration procedures, configuration mechanisms for this purpose do not exist.

In some scenarios, satellite coverage may not be available at some locations on a periodic basis. Therefore, this information should be provisioned in the network so that a better decision with respect to paging and mobility optimization may be taken accordingly.

Further, a core network should know accurate UE location for various purposes like paging optimization, sending PWS messages, mobility management, etc. However, for an Earth moving satellite, a radio (Uu) cell ID cannot be used to obtain accurate UE location, since the radio cell ID may be moving together with satellite.

Further, a typical beam footprint size for a low Earth orbit (LEO) satellite is in the range of 100 km-1000 km, which means that the radio cell ID alone in satellite context provides very inaccurate information about the UE location. Hence, the cell ID used on Uu system information block (SIB) content (and probably on Xn) are decoupled from cell ID used on an NG (N2) interface. The configuration for obtaining accurate user location for a core network is not available in the existing network configuration procedures.

In accordance with an embodiment of the present disclosure, a 5G network resource management (NRM) method and system are provided for various configurations related to satellite access coverage and related to mapping of a cell identity with a geostationary equatorial orbit (GEO) location. The NRM is enhanced so that it can support the required configuration to be done in the network. The NRM creation and updating may be done using a generic provisioning management service as defined in 3GPP TS 28.532. As such, the following information may be delivered using NRM extensions.

Information about satellite coverage availability or unavailability per NR satellite RAT type which are to be provided to an AMF. This information may be provided by an attribute satellite coverage information list (satelliteCoverageInfoList) having datatype satellite coverage information (SatelliteCoverageInfo), which includes the following attributes:
a) nRSatelliteRATtype in which possible values are NR (LEO), NR (medium Earth orbit (MEO)), NR (GEO), or NR (OTHERSAT).
b) locationInfo, which may have data type as LocationInfo and provide information about location and corresponding time windows for which the satellite coverage will be available and/or unavailable. The location Information may contain the following sub-attributes:
   location: Location (geographical area) under consideration.
   availability Windows: List of time windows at which the satellite coverage will be available.
   nonavailabilityWindows: List of time windows at which the satellite coverage will not be available.

Information related to mapping between mapped cell ID and geographical areas, which are to be configured in an AMF. This information may be required in a core network in case of an NTN for various purposes like paging optimization, mobility, user location information (ULI), area of interest, PWS messages, etc. This information will be provided by the attribute mappedCellInfoList having datatype MappedCellInfo, which includes following attributes:
a) nTNCellId, which is the identity of an NTN NR Cell. The format of the nTNCellId may be the same as the NR cell global identifier (CGI) as defined in TS 38.413.
b) mappedCellLocInfo, which provides information about mapped cell identity of the NTN NR cell and its mapped geo location.

In accordance with an embodiment of the present disclosure, coverage area information, including when and where the access may be available, may be configured beforehand so that corrective actions can be taken. Moreover, an AMF may use satellite coverage information as configured by operations, administration, and maintenance (OAM) to support satellite access by UEs with discontinuous coverage operations with respect to their mobility management. In such a scenario, an AMF may use satellite coverage information as configured by OAM for paging optimization.

In accordance with another embodiment of the present disclosure, satellite coverage information may be configured for a whole network. Further, a mapped cell ID information in an AMF, in case of an NTN, can be used for identifying a correct geo location for paging optimization and mobility management. Additionally, the mapped cell ID information in an AMF, in case of an NTN, can be used for identifying ULI, area of interest, PWS messages, etc.

An MnS is a set of offered capabilities for management and orchestration of network and services. An entity producing an MnS is an MnS producer (or producer). Further, an entity consuming an MnS is an MnS consumer (or consumer). In accordance with an embodiment, the producer and consumer may exchange satellite information via the steps below.

In step 1, the consumer may decide on various configurations related to satellite coverage information and mapped cell ID information.

Step 2 is related to procedures to be followed if a new AMF is to be deployed for NTN access. As such, at step 2.1, the consumer sends a createMOI request for AMF IOC as defined in 3GPP TS 28.532. This request will contain satelliteCoverageInfoList and mappedCellInfoList attributes. Thereafter, at step 2.2, the producer creates the AMFFunction MOI with the provided information as part of satelliteCoverageInfoList and mappedCellInfoList attributes. The producer sends this response to the consumer. At step 2.3, the producer will do necessary operations for the configuration of the AMF.

Step 3 is related to procedures to be followed if an existing AMF is to be modified. Accordingly, at step 3.1 the consumer sends a modifyMOIAttribute request for an AMF IOC as defined in 3GPP TS 28.532. The request contains an updated satelliteCoverageInfoList and mappedCellInfoList attributes. At step 3.2, the producer updates the AMFFunction MOI with the provided information as part of satelliteCoverageInfoList and mappedCellInfoList attributes. The producer sends this response to the consumer. Further, in step 3.2 the producer will do the necessary operations for the configuration of AMF.

In step 4, decisions related to paging, mobility, ULI, area of interest, PWS, etc., will be made based on the above-mentioned configurations.

### NRM Enhancements

NRM enhancements may include NRM definitions as listed in Tables 1 to 4 below.

The satelliteCoverageInfoList attribute will be added in an AMF IOC. It will be of type SatelliteCoverageInfo <<data type>>. This datatype defines various information about the satellite coverage.

Table 1 describes an Attributes for satelliteCoverageInfoList.

TABLE 1

| Attribute Name | Support | Cardinality | Description |
|---|---|---|---|
| nRSatelliteRATtype | M | 1 | It gives the RAT Type for NR satellite |
| | | | access. Possible values are NR(LEO), |
| | | | NR(MEO), NR(GEO) and |
| | | | NR(OTHERSAT). |
| locationInfo | M | 1 . . . * | It gives information about location |
| | | | (GeoArea as defined in 3GPP TS 28.622) |
| | | | and corresponding time windows for |
| | | | which the satellite coverage will be |
| | | | available or unavailable. |

Further, the locationInfo attribute will be of type LocationInfo <<data type>>. This datatype defines when and where the satellite coverage will be available and/or unavailable.

Table 2 describes an Attributes for locationInfo.

TABLE 2

| Attribute Name | Support | Cardinality | Description |
|---|---|---|---|
| location | M | 1 | Location (geographical area) under |
| | | | consideration to which the satellite |
| | | | coverage info belongs |
| availabilityWindows | CM | 1 | List of time windows at which the |
| | | | satellite coverage will be available for |
| | | | this location. Either |
| | | | availabilityWindows or |
| | | | nonAvailabilityWindows shall be |
| | | | present. |
| nonAvailabilityWindows | CM | 1 | List of time windows at which the |
| | | | satellite coverage will not be available |
| | | | for this location. Either |
| | | | availability Windows or |
| | | | nonAvailabilityWindows shall be |
| | | | present. |

The mappedCellInfoList attribute will be added in an AMFFunction IOC. It will be of type MappedCellInfo <<data type>>. This datatype defines various information about the mapped cell.

Table 3 describes an Attributes for mappedCellInfoList.

TABLE 3

| Attribute Name | Support | Cardinality | Description |
|---|---|---|---|
| nTNCellId | M | 1 | The identity of the NTN NR Cell. Its format is |
| | | | same as NR Cell Global Identifier (NR CGI) |
| | | | as defined in TS 38.413 |
| mappedCellLocInfo | M | 1 . . . * | It gives the information about mapped cell |
| | | | identity of the NTN NR cell and its mapped |
| | | | geo location. |

The mappedCellLocInfo attribute will be of type MappedCellLocInfo <<data type>>. This datatype defines various information about the mapped cell.

Table 4 describes an Attributes for MappedCellLocInfo.

TABLE 4

| Attribute Name | Support | Cardinality | Description |
|---|---|---|---|
| mappedCellID | M | 1 | It gives the mapped cell identity of the NTN |
| | | | NR cell that is mapped to a geo location. It is |
| | | | used for sending in next generation of |
| | | | aviation professionals (NGAP) messages for |
| | | | various proposes as explained above. Its |
| | | | format is same as NR CGI as defined in TS |
| | | | 38.413 |
| mappedGeoLocation | M | 1 | It gives the geographical area location that is |
| | | | mapped as fixed for a mappedCellID. |

The NRM provides the satelliteCoverageInfoList attribute in an AMFFunction IOC. Further, the mappedCellInfoList attribute is provided in the AMFFunction IOC. Therefore, satellite coverage information may be configured in an AMF with regard to both availability and unavailability for a given location. Further, mapped cell ID information i.e., mapping between cell ID and fixed geo location, may also be configured in in an AMF.

The coverage area information, including when and where the access will be available, will be configured beforehand so that the corrective actions can be taken.

The AMF may use satellite coverage information as configured by OAM to support satellite access by UEs with discontinuous coverage operation with respect to their mobility management.

The AMF may use satellite coverage information as configured by OAM for paging optimization.

The mapped cell ID information in an AMF, in case of an NTN, can be used for identifying a correct geo location for paging optimization and mobility management.

The mapped cell ID information in an AMF, in case of an NTN, can be used for identifying ULI, area of interest, PWS messages, etc.

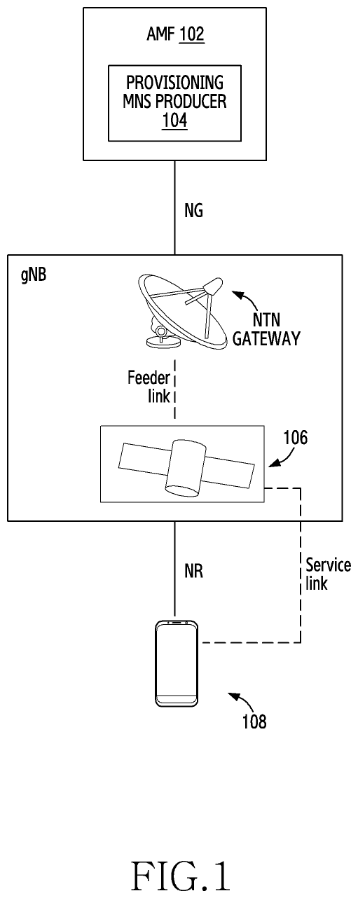

FIG. 1 illustrates an environment for NTN management, according to an embodiment.

Referring to FIG. 1, the environment includes an AMF 102, a provisioning MnS producer 104, a satellite 106, and a UE 108. An NTN may provide NR access to the UE 108, via the satellite 106 and an NTN gateway. The satellite 106 may communicate with the UE 108 via a service link. The NTN gateway and the satellite 106 may communicate via a feeder link. The satellite 106 may forward radio protocol received via the service link from the UE 108 to the NTN gateway via the feeder link, and vice-versa. The NTN gateway may serve multiple satellites and single satellite 106 may be served by multiple NTN gateways. The satellite 106 may include, but is not limited to, a communication satellite, a navigation satellite, a broadcasting satellite, a fixed satellite, etc. The UE 108 may be a system or device such as, a laptop computer, a desktop computer, a personal computer (PC), a notebook, a smartphone, a tablet, a server, a network server, a cloud-based server, etc.

Provisioning MnS, i.e., a type of MnS, may refer to a set of offered capabilities for management and orchestration of network and services. Entities producing the MnS may be referred to as provisioning MnS producers, while entities consuming the MnS may be referred to as MnS consumers.

In FIG. 1, the provisioning MnS producer 104 may communicate with a provisioning MnS consumer in a network. The provisioning MnS consumer and the provisioning MnS producer 104 may be implemented for the satellite 106 and for geographical location for the NTN management.

The provisioning MnS producer 104 may be a network node for the NTN management. The provisioning MnS producer 104 may be configured in the AMF 102. The provisioning MnS producer 104 and the AMF 102 may be implemented in a core network and the provisioning MnS consumer may be implemented as operations & maintenance (O&M) system.

The provisioning MnS producer 104 may configure the AMF 102 with satellite access coverage information in an NTN for NTN management. The provisioning MnS producer 104 may configure the AMF 102 with NR cell ID mapping information for geographical locations in an NTN for NTN management.

To provide satellite access coverage information in an NTN, the provisioning MnS producer 104 may receive a request including a satellite coverage parameter for creating an MOI of the AMF IOC, for providing the satellite access coverage information corresponding to an NR satellite RAT type, from the provisioning MnS consumer. The satellite access coverage information may be present in the provisioning MnS consumer. For configuring the satellite access coverage information in the AMF 102, the provisioning MnS consumer may send the request for creating the MOI of the AMF IOC to the provisioning MnS producer 104.

The request may include a satellite coverage parameter including attributes, such as NR satellite RAT type information and/or location information associated with each of one or more satellites. The location information associated may include sub attributes, such as a geographical location, a satellite coverage availability time window, and/or a satellite coverage non-availability time window.

Upon receiving the request to provide satellite access coverage information, the provisioning MnS producer 104 may create the MOI for providing the satellite access coverage information, based on the satellite coverage parameter. Thereafter, upon creation of the MOI of the AMF IOC, the provisioning MnS producer 104 may send a response of the creation of the MOI for the satellite access coverage information to the provisioning MnS consumer. Subsequently, the MOI of AMF IOC may be configured in the AMF 102.

Modified satellite access coverage information corresponding to an NR satellite RAT type may be configured in the AMF 102, by modifying the MOI of AMF IOC due to the presence of updated satellite access coverage information in the provisioning MnS consumer. In such case, the provisioning MnS consumer may send a request for performing an update on the MOI of the AMF IOC for providing the modified satellite access coverage information corresponding to the NR satellite RAT type.

The provisioning MnS producer 104 may receive a request comprising an updated satellite coverage parameter, for performing the update on the MOI of the AMF IOC for providing modified satellite access coverage information corresponding to the NR satellite RAT type, from the provisioning MnS consumer. The updated satellite coverage parameter may include updated attributes such as updated NR satellite RAT type information and updated location information associated with each of one or more satellites. The updated location information associated with each of the one or more satellites may include updated sub attributes such as an updated geographical location, an updated satellite coverage availability time window, and/or an updated satellite coverage non-availability time window.

Upon receiving the request to provide the modified satellite access coverage information, the provisioning MnS producer 104 may perform the update on the MOI for providing the modified satellite access coverage information, based on the updated satellite coverage parameter. Thereafter, upon updating the MOI, the provisioning MnS producer 104 may send, to the provisioning MnS consumer, a response based on the updated MOI for providing the modified satellite access coverage parameter. Thus, the satellite access coverage information related to availability of the satellite 106 in the NTN location may be provided. The satellite access coverage information configured in the AMF 102 may be used for making better decisions with respect to paging and mobility optimization.

To provide the UE location by the corresponding NTN NR cell ID mapping information for geographical locations in the NTN, the provisioning MnS producer 104 may receive, from the provisioning MnS consumer, a request to create an MOI of the AMF 102 IOC for providing mapping information. The request may include a mapped cell parameter corresponding to an NTN NR cell. The mapping information may be associated with mapping of one or more cell IDs with one or more geographical locations. The provisioning MnS consumer may include the NTN NR cell ID information. For configuring the NTN NR cell ID information in the AMF 102, the provisioning MnS consumer may send the request for creating the MOI of the AMF IOC to the provisioning MnS producer 104.

The request may include the mapped cell parameters. The mapped cell parameter may include attributes, such as an NTN cell ID of an NTN NR cell and mapped cell location information of the NTN NR cell. The mapped cell location information of the NTN NR cell may include sub attributes, such as mapped cell IDs corresponding to the NTN cell ID and mapped geographical locations corresponding to the mapped cell ID.

Upon receiving the request to provide the mapping information associated with mapping of the one or more cell IDs with the one or more geographical locations, the provisioning MnS producer 104 may create the MOI for providing the mapping information, based on the mapped cell parameter present in the request. Thereafter, the provisioning MnS producer 104 may send a response, to the provisioning MnS consumer, based on the creation of the MOI for the mapping information. The NTN NR cell ID may be mapped with one or more mapped cell ID and each of the mapped cell ID may be mapped with a particular geographical location.

Modified mapping information corresponding to the mapping of the one or more cell identity with the one or more geographical locations may be configured in the AMF 102, by modifying the MOI of AMF IOC due to the presence of updated mapping information in the provisioning MnS consumer. In such case, the provisioning MnS consumer may send a request for performing an update on the MOI of the AMF IOC for providing the modified mapping information corresponding to the mapping of the one or more cell IDs with the one or more geographical locations.

The provisioning MnS producer 104 may receive a request including an updated mapped cell parameter corresponding to the NTN NR cell for performing the update on the MOI for providing modified mapping information corresponding to the mapping of the one or more cell IDs with the one or more geographical locations, from the provisioning MnS consumer. The updated mapped cell parameter may include attributes such as an updated NTN cell ID of an NTN NR cell and updated mapped cell location information of the NTN NR cell. The updated mapped cell location information of the NTN NR cell may include sub attributes such as updated mapped cell IDs corresponding to the NTN cell ID and updated mapped geographical locations corresponding to the mapped cell ID.

Upon receiving the request for providing the modified mapping information, the provisioning MnS producer 104 may perform the update on the MOI for providing the modified mapping information, based on the updated mapped cell parameter present in the provisioning MnS consumer. Thereafter, the provisioning MnS producer 104 may send a response of the updated MOI for the modified mapping information to the provisioning MnS consumer. Thus, the mapping information related to NTN NR cell ID and the geographical locations may be provided. The mapping information configured in the AMF 102 may be used for making better decisions with respect to paging and mobility optimization.

Satellite access coverage information in an NTN may be used for identifying the availability of a satellite in an area. The NTN NR cell ID mapping information for geographical locations in the NTN may be used for identifying a UE location in an area or a cell. The satellite access coverage information and the mapping information configured in the AMF 102 may be used for identifying a communication network between the UE 108 and the satellite 106 in the area. In a given UE location, the AMF 102 may be able to provide the satellite access coverage information for identifying the availability of the satellite in the given UE location.

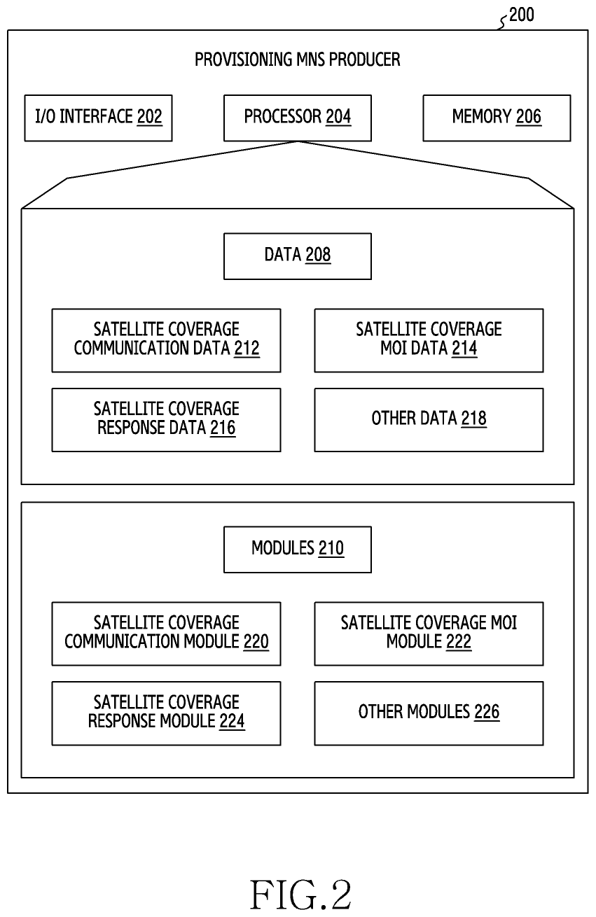

FIG. 2 illustrates a provisioning MnS producer for providing satellite access coverage information in an NTN, according to an embodiment.

Referring to FIG. 2, the provisioning MnS producer 200 may include an input/output (I/O) interface 202, a processor 204 (e.g., a central processing unit (CPU) or CPUs), and a memory 206. The I/O interface 202 and the memory 206 may be communicatively coupled to the processor 204. The processor 204 may include at least one data processor for executing program components for executing user or system-generated requests. The memory 206 may be communicatively coupled to the processor 204. The memory 206 stores instructions, which are executable by the processor 204, and upon execution, may cause the processor 204 to perform NTN management.

The processor 204 include one or more modules 210 and data 208. The one or more modules 210 may be configured for NTN management, and the one or more modules 210 may be configured to use the data 208 for NTN management. Alternatively, each of the one or more modules 210 may be hardware, which may be outside the processor 204 and coupled with the provisioning MnS producer.

As used herein, the term modules 210 may include, but is not limited to, an application specific integrated circuit (ASIC), an electronic circuit, a field-programmable gate array (FPGA), a programmable system-on-chip (PSoC), a combinational logic circuit, and/or other suitable components that provide described functionality.

One or more of the modules 210 may be implemented by software or a combination of hardware and software. The one or more modules 210 when configured with the described functionality defined in the disclosure may result in a novel hardware or may be considered as a special purpose processor. However, the disclosure is not limited thereto, and as such, the disclosure may be implemented in another way according to various other example embodiments.

Further, the I/O interface 202 is coupled with the processor 204, through which an input signal or/and an output signal is communicated. For example, the provisioning MnS producer 200 may receive the request from the provisioning MnS consumer via the I/O interface 202. The I/O interface 202 may include an internal interface or an external interface.

The modules 210 include a satellite coverage communication module 220, a satellite coverage MOI module 222, a satellite coverage response module 224, and other modules 226. It will be appreciated that such aforementioned modules 210 may be represented as a single module or a combination of different modules.

The data 208 includes, for example, satellite coverage communication data 212, satellite coverage MOI data 214, satellite coverage response data 216, and other data 218.

The satellite coverage communication module 220 may be configured to receive the request comprising the satellite coverage parameter for creating the MOI of the AMF IOC for providing the satellite access coverage information corresponding to the NR satellite RAT type, from the provisioning MnS consumer. The satellite coverage communication module 220 may be present in the provisioning MnS producer 200. The satellite access coverage information may be available with the provisioning MnS consumer.

The satellite coverage parameter present in the request may include attributes, such as NR satellite RAT type information and location information associated with each of one or more satellites. The location information associated with each of one or more satellites may include sub attributes such as the geographical location, the satellite coverage availability time window, and the satellite coverage non-availability time window.

At least one NR satellite RAT type information may provide the RAT type for the NR satellite access. For example, the possible RAT type values may be NR (LEO), NR (MEO), NR (GEO), and NR (OTHERSAT).

The at least one location information associated with each of one or more satellites may provide information about the satellite location and corresponding time window for the satellite coverage availability or unavailability.

The geographical location associated with the satellite may refer to a geographical area corresponding to the satellite coverage information. The satellite coverage availability time window may refer to a list of time windows corresponding to the availability of the satellite coverage in the location. The satellite coverage non-availability time window may refer to a list of time windows corresponding to the unavailability of the satellite coverage in the location.

The request received from the provisioning MnS consumer may be stored as the satellite coverage communication data 212 in the provisioning MnS producer 200. The request for providing the satellites access coverage information may correspond to the NR satellite RAT type.

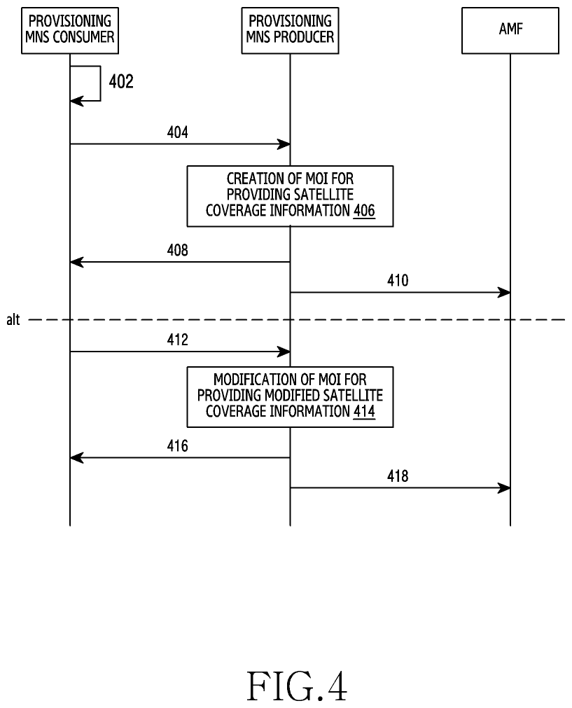

FIG. 4 is a signal flow diagram illustrating a method for providing satellite access coverage information in an NTN, according to an embodiment.

Referring to FIG. 4, satellite access coverage information may be present in the provisioning MnS consumer in step 402.

In step 404, the provisioning MnS consumer provides the satellite access coverage information to the provisioning MnS producer by sending a request to create the MOI of the AMF IOC for providing the satellite access coverage information corresponding to the NR satellite RAT type.

Referring again to FIG. 2, the satellite coverage MOI module 222 may create the MOI of the AMF IOC for providing the satellite access coverage information, based on the satellite coverage parameter present in the provisioning MnS consumer, upon receiving the request for creating the MOI of the AMF IOC. The MOI of the AMF IOC may be created using the attributes and sub attributes associated with the satellite coverage parameter. The MOI created by the provisioning MnS producer 200 may be stored as the satellite coverage MOI data 214 in the provisioning MnS producer 200. The MOI may be created for providing the satellites access coverage information comprising the satellite coverage parameter.

Referring again to FIG. 4, in step 406, the provisioning MnS producer creates the MOI for the AMF IOC for providing the satellite access coverage information to the AMF, upon receiving the request.

Referring again to FIG. 2, the satellite coverage response module 224 may send the response of the creation of the MOI for the satellite access coverage information to the provisioning MnS consumer, upon creation of the MOI of the AMF IOC. Further, the MOI created may be configured in the AMF. The response of the MOI created by the provisioning MnS producer 200 may be stored as the satellite coverage response data 216 in the provisioning MnS producer 200. The response may be sent to the provisioning MnS consumer indicating the creation of the MOI for providing the satellites access coverage.

Referring again to FIG. 4, in step 408, the provisioning MnS producer sends a response regarding creation of the MOI of the AMF IOC.

In step 410, the provisioning MnS producer sends the configuration of the creation of the MOI for implementing the creation of the MOI to the AMF.

Modified satellite access coverage information corresponding to the NR satellite RAT type may be configured in the AMF by modifying the MOI of AMF IOC due to the presence of updated satellite access coverage information in the provisioning MnS consumer. In such a case, the provisioning MnS consumer may send a request for performing an update on the MOI of the AMF IOC for providing the modified satellite access coverage information corresponding to the NR satellite RAT type.

Referring again to FIG. 2, the satellite coverage communication module 220 may be configured to receive the request comprising the updated satellite coverage parameter for performing the update on the MOI of the AMF IOC for providing the modified satellite access coverage information corresponding to the NR satellite RAT type, from the provisioning MnS consumer. The updated satellite access coverage information may be received in the provisioning MnS consumer.

The updated satellite coverage parameter present in the request may include attributes such as the updated NR satellite RAT type information and the updated location information associated with each of one or more satellites. The updated location information associated with each of the one or more satellites may include sub attributes such as the updated geographical location, the updated satellite coverage availability time window, and/or the updated satellite coverage non-availability time window.

The updated at least one NR satellite RAT type information may provide the updated RAT type for the NR satellite access. For instance, the possible updated RAT type values may be the NR (LEO), the NR (MEO), the NR (GEO) and the NR (OTHERSAT).

The updated location information associated with each of the one or more satellites may provide information about the updated satellite location and corresponding updated time window for the satellite coverage availability or unavailability.

The updated geographical location associated with the satellite may refer to an updated geographical area corresponding to the satellite coverage information. The updated satellite coverage availability time window may refer to an updated list of time windows corresponding to the availability of the satellite coverage in the location. The updated satellite coverage non-availability time window may refer to an updated list of time windows corresponding to the unavailability of the satellite coverage in the location.

The request including the updated satellite coverage parameter, received from the provisioning MnS consumer, may be stored as the satellite coverage communication data 212 in the provisioning MnS producer 200. The request for providing the modified satellites access coverage information may correspond to the updated NR satellite RAT type.

Referring again to FIG. 4, the modified satellite access coverage information may be present in the provisioning MnS consumer in step 402. The provisioning MnS consumer may provide the modified satellite access coverage information to the AMF.

In step 412, to provide the modified satellite access coverage information, the provisioning MnS consumer may send, to the provisioning MnS producer, a request to create the MOI of the AMF IOC for providing the modified satellite access coverage information corresponding to the updated NR satellite RAT type.

Referring again to FIG. 2, the satellite coverage MOI module 222 may create the MOI of the AMF IOC for the providing the modified satellite access coverage information, based on the updated satellite coverage parameter present in the provisioning MnS consumer, upon receiving the request for performing the update on the MOI of the AMF IOC. The update on the MOI of the AMF IOC may be performed using the attributes and sub attributes associated with the updated satellite coverage parameter. The update performed on the MOI by the provisioning MnS producer 200 may be stored as the satellite coverage MOI data 214 in the provisioning MnS producer 200. The updated MOI may be performed for providing the modified satellites access coverage information including the updated satellite coverage parameter.

Referring again to FIG. 4, in step 414, the provisioning MnS producer performs an update on the MOI for AMF IOC for providing the modified satellite access coverage information to the AMF, upon receiving the request.

Referring again to FIG. 2, the satellite coverage response module 224 may send the response of the updated MOI for the modified satellite access coverage information to the provisioning MnS consumer, upon performing the update on the MOI of the AMF IOC. Further, the update performed on the MOI may be configured in the AMF. The response of the updated MOI performed by the provisioning MnS producer 200 may be stored as the satellite coverage response data 216 in the provisioning MnS producer 200. The response may be sent to the provisioning MnS consumer indicating the performance of updating the MOI for providing the modified satellites access coverage information.

Referring again to FIG. 4, in step 416, the provisioning MnS producer sends a response to the provisioning MnS consumer regarding the update of the MOI, by modifying the MOI for providing the modified satellite access coverage information.

In step 418, the provisioning MnS producer sends, to the AMF, the configuration of the updated MOI for the AMF for implementing the updated MOI.

As described above, satellite access coverage information may be configured in the AMF with regard to both availability and unavailability of the satellite in any given area. Therefore, coverage area information, including when and where the access may be available, may be provided. The configuration of the satellite access coverage information in the AMF may help in taking corrective actions beforehand. Further, the satellite access coverage information may be provided for the whole network.

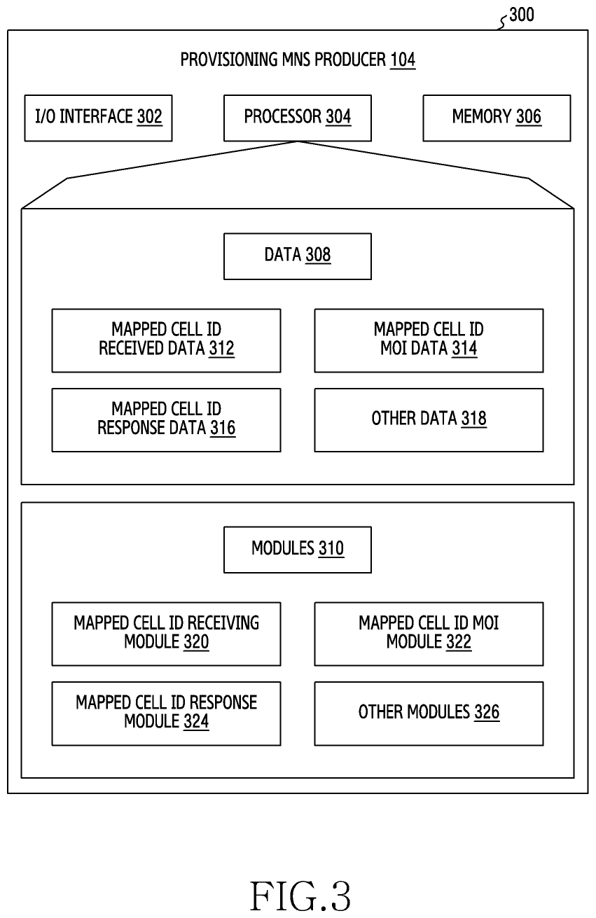

FIG. 3 illustrates a provisioning MnS producer for providing NTN NR cell identity mapping information for geographical locations in an NTN, according to an embodiment.

Referring to FIG. 3, a provisioning MnS producer 300 includes an I/O interface 302, a processor 304, and a memory 306. The I/O interface 302 and the memory 306 may be communicatively coupled to the processor 304. The processor 304 may include a data processor for executing program components for executing user or system-generated requests. The memory 306 may be communicatively coupled to the processor 304. The memory 206 stores instructions, which are executable by the processor 304, and upon execution, may cause the processor 304 to perform NTN management.

The processor 304 may include one or more modules 310 and data 308. The modules 310 may be configured for NTN management. The one or more modules 310 may be configured to use the data 308 for NTN management.

Alternatively, each of the one or more modules 310 may be a hardware which may be outside the processor 304 and coupled with the provisioning MnS producer 300.

As used herein, the term modules 310 may include, but is not limited to, an ASIC, an electronic circuit, a FPGA, a PSoC, a combinational logic circuit, and/or other suitable components that provide described functionality.

One or more of the modules 310 may be implemented by software or a combination of hardware and software. The one or more modules 310, when configured with the described functionality defined in the disclosure, may result in a novel hardware or may be considered as a special purpose processor. However, the disclosure is not limited thereto, and as such, the disclosure may be implemented in another way according to various other example embodiments.

The I/O interface 302 is coupled with the processor 304 through which an input signal and/or an output signal is communicated. For example, the provisioning MnS producer 300 may receive the request from the provisioning MnS consumer via the I/O interface 302. The I/O interface 302 may include an internal interface or an external interface.

The modules 310 include a mapped cell ID receive module 320, a mapped cell ID MOI module 322, a mapped cell ID response module 324, and other modules 326. It will be appreciated that such aforementioned modules 310 may be represented as a single module or a combination of different modules.

The data 308 includes mapped cell ID receive data 312, mapped cell ID MOI metric data 314, mapped cell ID response data 316, and other data 318.

The mapped cell ID receiving module 320 may be configured to receive the request including the mapped cell parameter corresponding to the NTN NR cell for creating the MOI of the AMF IOC for providing the mapping information associated with mapping of the one or more cell identity with the one or more geographical locations, from the provisioning MnS consumer. The mapping information may be received from the provisioning MnS consumer.

The mapped cell parameter present in the request may include the attributes such as the NTN cell ID of at least one NTN NR cell and the mapped cell location information of the NTN NR cell. The mapped cell location information of the NTN NR cell may include sub attributes such as the mapped cell IDs corresponding to the NTN cell ID and the mapped geographical locations corresponding to the mapped cell ID.

The NTN cell ID of an NTN NR cell may refer to the cell ID of the NTN NR cell. The cell ID format may be similar to an NR CGI. The mapped cells locations information of the NTN NR cell may provide the mapped cell identity information and mapped geographical location.

The mapped cell IDs corresponding to the NTN cell ID may provide mapped cell identity information corresponding to the NTN NR cell in the mapped geographical location. The mapped cell IDs may be used for sending NGAP messages for various purposes.

A format of the mapped cell IDs may be similar to an NR CGI.

The NTN NR cell ID may be mapped with one or more mapped cell IDs and each of the mapped cell IDs may be mapped with a particular geographical location. The mapped geographical locations corresponding to the mapped cell ID may provide the geographical area location mapped with the UE. The mapped geographical locations may be with respect to each mapped cell ID.

The request received from the provisioning MnS consumer may be stored as the mapped cell ID receiving data 312 in the provisioning MnS producer 300. The request for providing the mapping information may be associated with mapping of the one or more cell IDs with the one or more geographical locations.

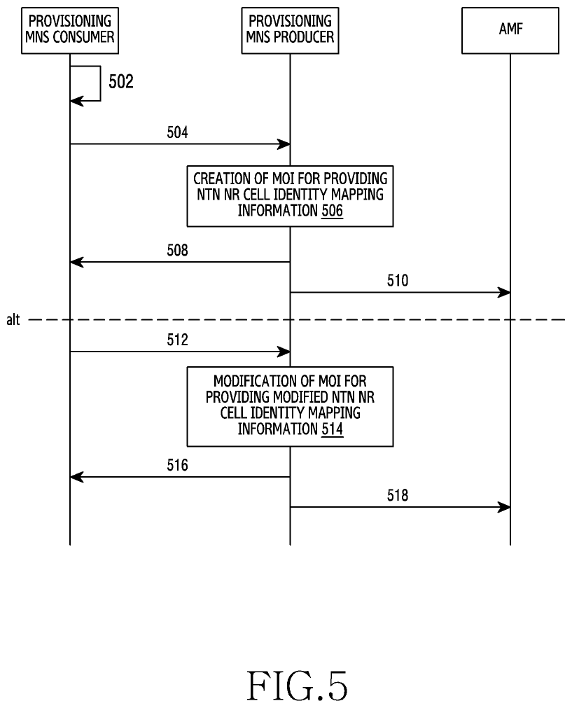

FIG. 5 is a signal flow diagram illustrating a method for providing NTN NR cell identity mapping information for geographical locations in an NTN, according to an embodiment.

Referring to FIG. 5, mapping information may be present in the provisioning MnS consumer in step 502. The provisioning MnS consumer may provide the mapping information to the AMF.

To provide the mapping information, in step 504, the provisioning MnS consumer sends, to the provision MnS producer, a request to creating the MOI of the AMF IOC for providing the mapping information associated with mapping of the one or more cell identity with the one or more geographical locations.

Referring again to FIG. 3, the mapped cell ID MOI module 322 may create the MOI of the AMF IOC for providing the mapping information, based on the mapped cell parameter present in the provisioning MnS consumer, upon receiving the request for creating the MOI of the AMF IOC. The MOI of the AMF IOC may be created using the attributes and sub attributes associated with the mapped cell parameter. The mapped cell parameter may correspond to the NTN NR cell. The MOI created by the provisioning MnS producer 300 may be stored as the mapped cell ID MOI data 314 in the provisioning MnS producer 300. The MOI may be created for providing the mapping information comprising the mapped cell parameter.

Referring again to FIG. 5, in step 506, the provisioning MnS producer creates the MOI for the AMF IOC at step 506 for providing the mapping information to the AMF, upon receiving the request.

Referring again to FIG. 3, the mapped cell ID response module 324 may send the response of the creation of the MOI for the mapping information to the provisioning MnS consumer, upon creation of the MOI of the AMF IOC. Further, the MOI created may be configured in the AMF. The response of the MOI created by the provisioning MnS producer 300 may be stored as the mapped cell ID response data 316. The response may be sent to the provisioning MnS consumer indicating the creation of the MOI for providing the mapping information of the geographical location. The NTN NR cell ID may be mapped with one or more mapped cell IDs and each of the mapped cell IDs may be mapped with a particular geographical location.

Referring again to FIG. 5, in step 508, the provisioning MnS producer sends a response, provisioning MnS consumer, regarding creation of the MOI of the AMF IOC, upon creation of the MOI for providing the mapping information.

In step 510, the provisioning MnS producer sends, to the AMF, the configuration of the creation of the MOI for the AMF for implementing the creation of the MOI.

Modified mapping information corresponding to the mapping of the one or more cell identity with the one or more geographical locations may also be configured in the AMF, by modifying the MOI of AMF IOC due to the presence of updated mapping information in the provisioning MnS consumer. In such a case, the provisioning MnS consumer may send the request for performing the update on the MOI of the AMF IOC for providing the modified mapping information corresponding to the mapping of the one or more cell identity with the one or more geographical locations.

Referring again to FIG. 3, the mapped cell ID receiving module 320 may be configured to receive the request comprising the updated mapped cell parameter corresponding to the NTN NR cell for performing the update on the MOI for providing modified mapping information corresponding to the mapping of the one or more cell identity with the one or more geographical locations, from the provisioning MnS consumer. The updated mapping information may be present in the provisioning MnS consumer.

The updated mapped cell parameter present in the request may include the attributes such as the NTN cell ID of at least one NTN NR cell and the updated mapped cells locations information of the NTN NR cell. The updated mapped cells locations information of the NTN NR cell may include sub attributes such as the updated mapped cell IDs corresponding to the NTN cell ID and the updated mapped geographical locations corresponding to the mapped cell ID. The updated mapped cell parameter refers to the change in the value or information corresponding to the mapped cell parameter.

The request including the updated cell ID parameter, received from the provisioning MnS consumer, may be stored as the mapped cell ID receiving data 312 in the provisioning MnS producer 300. The request for providing the modified mapping information may correspond to the information corresponding to the mapping of the one or more cell identity with the one or more geographical locations.

Referring again FIG. 5, the modified mapping information may be present in the provisioning MnS consumer in step 502. The provisioning MnS consumer may provide the modified mapping information to the AMF.

To provide the modified mapping information, in step 512, the provisioning MnS consumer sends, provisioning MnS producer, a request to create the MOI of the AMF IOC for providing the modified mapping information corresponding to the mapping of the one or more cell identity with the one or more geographical locations.

Referring again to FIG. 3, the mapped cell ID MOI module 322 may create the MOI of the AMF IOC for providing the modified mapping information, based on the updated mapped cell parameter present in the provisioning MnS consumer, upon receiving the request for performing the update on the MOI of the AMF IOC. The update of MOI of the AMF IOC may be performed using the attributes and the sub attributes associated with the updated mapped cell parameter. The update performed on the MOI by the provisioning MnS producer 300 may be stored as the mapped cell ID MOI data 314 in the provisioning MnS producer 300. The updated MOI may be performed for providing the modified mapping information including the updated mapped cell parameter. The updated mapped cell parameters may correspond to the NTN NR cell.

Referring again to FIG. 5, in step 514, the provisioning MnS producer updates the MOI for the AMF IOC for providing the modified mapping information to the AMF, upon receiving the request.

Referring again to FIG. 3, the mapped cell ID response module 324 may send the response of the updated MOI for the modified mapping information to the provisioning MnS consumer, upon performing the update on the MOI of the AMF IOC. Further, the update performed on the MOI may be configured in the AMF. The response of the updated MOI performed by the provisioning MnS producer 300 may be stored as the mapped cell ID response data 316 in the provisioning MnS producer 300. The response may be sent to the provisioning MnS consumer indicating the performance of updating the MOI for providing the modified mapping information.

Referring again to FIG. 5, in step 5161, the provisioning MnS producer sends a response, to the provisioning MnS consumer, regarding the update of the MOI, upon updating the MOI for providing the modified mapping information.

In step 518, the provisioning MnS producer sends, to the AMF, the configuration of the updated MOI for the AMF for implementing the updated MOI at step 518.

As described above, mapping information, such as mapping of the one or more cell identity and the one or more geographical locations, may be configured in the AMF. The mapping information configured in the AMF may be used for identifying correct geographical location for paging optimization and mobility management. Further, the mapping information configured in the AMF may be used for identifying ULI, an area of interest, PWS messages, etc.

Various methods will be described below with reference to flow charts in the drawings. In each of the flow charts, a method may include one or more operations. The method may be described in the general context of computer executable instructions. Generally, computer executable instructions can include routines, programs, objects, components, data structures, procedures, modules, and functions, which perform particular functions or implement particular abstract data types.

Additionally, the order in which each method is described is not intended to be construed as a limitation, and any number of the described method blocks can be combined in any order to implement the method.

Additionally, individual blocks may be deleted from the methods without departing from the scope of the subject matter described herein. Furthermore, a method can be implemented in any suitable hardware, software, firmware, or combination thereof.

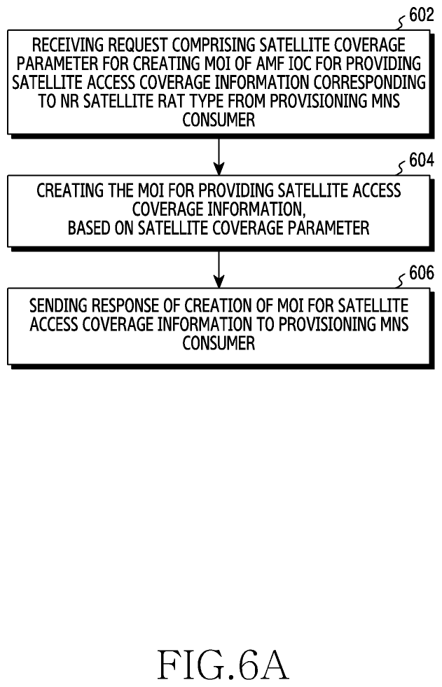

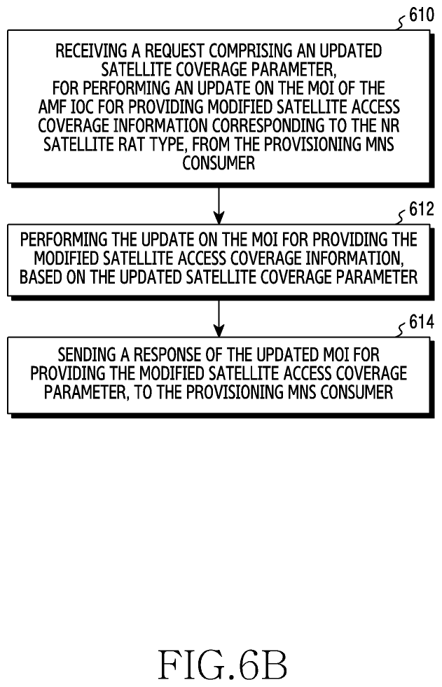

FIG. 6A is a flow chart illustrating a method for providing satellite access coverage information in an NTN, according to an embodiment.

Referring to FIG. 6A, in step 602, a provisioning MnS producer receives, from a provisioning MnS consumer, a request to create an MOI of an AMF IOC for providing satellite access coverage information corresponding to an NR satellite RAT type. The request may include the satellite coverage parameter.

In step 604, the provisioning MnS producer creates the MOI for providing the satellite access coverage information. The MOI may be created based on the satellite coverage parameter present in the provisioning MnS consumer. The MOI may be created after receiving the request for creating the MOI of AMF IOC for providing the satellite access coverage information.

In step 606, the provisioning MnS producer, sends, to the provisioning MnS consumer, a response of the creation of the MOI for the satellite access coverage information. The response may be sent after creation of the MOI of AMF IOC. Thereafter, the MOI of the AMF IOC may be configured in the AMF for providing the satellite access coverage information.

FIG. 6B is a flow chart illustrating a method for providing modified satellite access coverage information in an NTN, according to an embodiment.

Referring to FIG. 6B, in step 610, a provisioning MnS producer receives, from a provisioning MnS consumer, a request to perform an update on an MOI of an AMF IOC for providing modified satellite access coverage information corresponding to an NR satellite RAT type. The request may include the updated satellite coverage parameter.

In step 612, the provisioning MnS producer updates the MOI for providing the modified satellite access coverage information, based on the updated satellite coverage parameter.

In step 614, the provisioning MnS producer sends, to the provisioning MnS consumer, the response of the updated MOI for providing the modified satellite access coverage parameter.

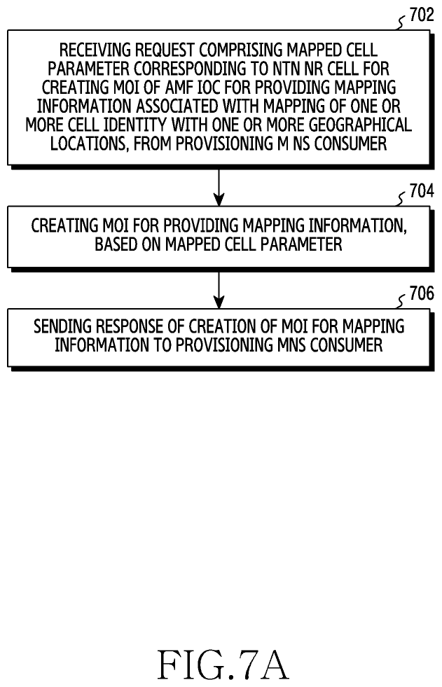

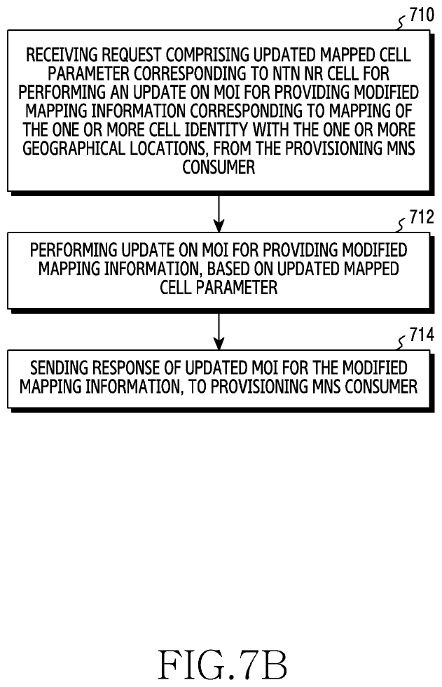

FIG. 7A is a flow chart illustrating a method for providing NTN NR cell identity mapping information for geographical locations in an NTN, according to an embodiment.

Referring to FIG. 7A, in step 702, a provisioning MnS producer receives, from a provisioning MnS consumer, a request to create an MOI of an AMF IOC for providing mapping information associated with mapping of one or more cell IDs with the one or more geographical locations. The request may include a mapped cell parameter corresponding to an NTN NR cell

In step 704, the provisioning MnS producer creates the MOI for providing the mapping information, based on the mapped cell parameter in the provisioning MnS consumer.

In step 706, the provisioning MnS producer sends, to the provisioning MnS consumer, a response of the creation of the MOI for the mapping information. Thereafter, the MOI of the AMF IOC may be configured in the AMF.

FIG. 7B is a flow chart illustrating a method for providing modified NTN NR cell identity mapping information for geographical locations in an NTN, according to an embodiment.

Referring to FIG. 7B, in step 710, a provisioning MnS producer receives, from a provisioning MnS consumer, a request to provide modified mapping information corresponding to the mapping of one or more cell IDs with one or more geographical locations. The request includes an updated mapped cell parameter corresponding to an NTN NR cell for performing an update on the MOI

In step 712, the provisioning MnS producer updates the MOI for providing the modified mapping information, based on the updated mapped cell parameter.

In step 714, the provisioning MnS producer sends, to the provisioning MnS consumer, a response based on the updated MOI, for providing the modified mapping information.

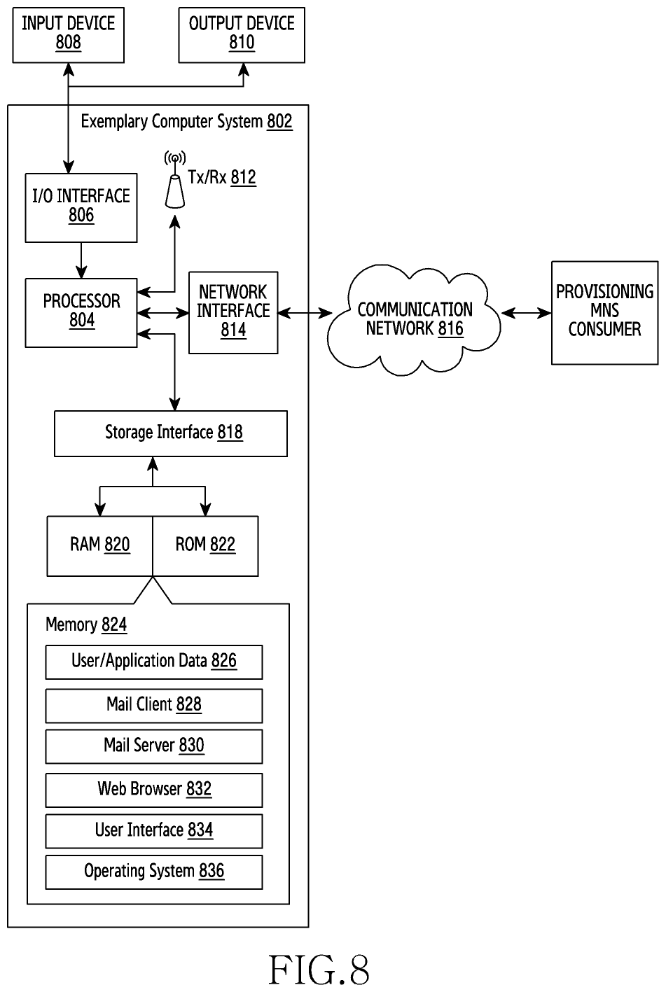

FIG. 8 illustrates a system for NTN management, according to an embodiment.

Referring to FIG. 8, the system 802 may be a provisioning MnS producer. Thus, the system 802 may be used for creating an MOI of an AMF IOC. The system 80s and a provisioning MnS consumer may be connected via a network, e.g., communication network 816. A network interface 814 may include an internal interface or an external interface.

The systems 802 includes processor 804, e.g., a CPU or a controller. The processor 804 may include at least one data processor. The processor 804 may include specialized processing units such as integrated system (bus) controllers, memory management control units, floating point units, graphics processing units, digital signal processing units, etc.

The processor 804 may be configured to communicate through a transmission/reception unit 812 or communicate with one or more devices, e.g., input device 808 and output device 810, via an I/O interface 806. The I/O interface 806 may employ communication protocols/methods such as, without limitation, audio, analog, digital, monoaural, radio corporation of America (RCA), stereo, Institute of Electrical and Electronics Engineers (IEEE)-1394, serial bus, universal serial bus (USB), infrared, PS/2, Bayonet Neill-Concelman (BNC), coaxial, component, composite, digital visual interface (DVI), high-definition multimedia interface (HDMI), radio frequency (RF) antennas, S-Video, video graphics array (VGA), IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

The input device 808 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device 810 may be a printer, fax machine, video display (e.g., cathode ray tube (CRT), liquid crystal display (LCD), light-emitting diode (LED), plasma, plasma display panel (PDP), Organic light-emitting diode display (OLED) or the like), audio speaker, etc.

The processor 804 may be configured to communicate with the communication network 816 via the network interface 814. The system 802 may communicate with the provisioning MnS consumer via the communication network 816. The network interface 814 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc.

The communication network 816 may include, without limitation, a direct interconnection, local area network (LAN), wide area network (WAN), wireless network (e.g., using wireless application protocol (WAP)), the Internet, etc.

The communication network 816 may also include, but is not limited to, an e-commerce network, a peer to peer (P2P) network, the Internet, Wi-Fi, etc.

The network interface 814 may employ connection protocols include, but not limited to, direct connect, Ethernet (e.g., twisted pair 10/100/1000 Base T), TCP/IP, token ring, IEEE 802.11a/b/g/n/x, etc.

The processor 804 may be configured to communicate with a memory 824 via a storage interface 818. The storage interface 818 may connect to the memory 824 including, without limitation, memory drives, removable disc drives, etc., employing connection protocols such as serial advanced technology attachment (SATA), integrated drive electronics (IDE), IEEE-1394, USB, fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory 824, which include random access memory (RAM) 820 and read only memory (ROM) 822, may store a collection of program or database components, including, without limitation, user interface 834, an operating system (OS) 836, web browser 832, a mail server 830, a mail client 828, user/application data 826, etc.

For example, the system 802 may store the user/application data 826, such as, data, variables, records, etc., as described in this disclosure. Such databases may be implemented as fault-tolerant, relational, scalable, secure databases such as Oracle® or Sybase®.

The OS 836 may facilitate resource management and operation of the system 802. Examples of the OS 836 may include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10, etc.), APPLE® IOS™, GOOGLE® ANDROID™, BLACKBERRY® OS, etc.

The system 802 may implement the web browser 832 stored program component. The web browser 832 may be a hypertext viewing application, for example MICROSOFT® INTERNET EXPLORER™, GOOGLE® CHROME™, MOZILLA® FIREFOX™, APPLE® SAFARI™, etc. Secure web browsing may be provided using secure hypertext transport protocol (HTTPS), secure sockets layer (SSL), transport layer security (TLS), etc. Web browsers 932 may utilize facilities such as AJAX™, DHTML™, ADOBE®. FLASH™, JAVASCRIPT™, JAVA™, application programming interfaces (APIs), etc.

The system 802 may implement the mail server 830 stored program component. The mail server may be an Internet mail server such as Microsoft Exchange, or the like. The mail server may utilize facilities such as ASP™, ACTIVEX™, ANSI™ C++/C#, MICROSOFT®, .NET™, CGI SCRIPTS™, JAVA™, JAVASCRIPT™, PERL™, PHP™, PYTHON™ WEBOBJECTS™, etc. The mail server 830 may utilize communication protocols such as Internet message access protocol (IMAP), messaging application programming interface (MAPI), MICROSOFT® exchange, post office protocol (POP), simple mail transfer protocol (SMTP), etc.

The system 802 may implement the mail client 828 stored program component. The mail client 828 may be a mail viewing application, such as APPLE® MAIL™, MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the disclosure. A computer-readable storage medium refers to any type of physical memory on which information or data readable by a processor may be stored. Thus, a computer-readable storage medium may store instructions for execution by one or more processors, including instructions for causing the processor(s) to perform operations or stages consistent with the embodiments described herein. The term “computer-readable medium” should be understood to include tangible items and exclude carrier waves and transient signals, i.e., be non-transitory. Examples include RAM, ROM, volatile memory, non-volatile memory, hard drives, compact disc (CD) ROM, digital video disc (DVDs), flash drives, disks, and any other known physical storage media.

The disclosure provides the ability to configure satellite access coverage information in the AMF with regard to both availability and unavailability of the satellite in any given area. Therefore, the disclosure provides coverage area information, including when and where access may be available. The configuration of the satellite access coverage information in the AMF may help in taking corrective actions beforehand. Further, the satellite access coverage information may be provided for whole network.

The disclosure also provides the ability to configure mapping information such as mapping of the one or more cell identity and the one or more geographical locations in the AMF. The mapping information configured in the AMF may be used for identifying correct geographical locations for paging optimization and mobility management. Further, the mapping information configured in the AMF may be used for identifying ULI, an area of interest, PWS messages, etc. Further, the satellite access coverage information, including when and where the access to the satellite may be available, may be configured beforehand so that the corrective actions may be taken.

An AMF may use satellite coverage information to support satellite access by UEs with discontinuous coverage operation with respect to corresponding mobility management. Further, the AMF may use satellite coverage information for paging optimization.

The mapping information configured in the AMF may be used for identifying correct geographical location for paging optimization and mobility management. Further, the mapping information configured in the AMF may be used for identifying ULI, an area of interest, PWS messages, etc.

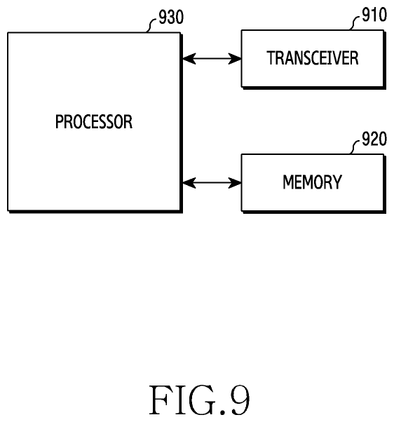

FIG. 9 illustrates a UE or a base station according to an embodiment.

Referring to FIG. 9, the UE or the base station includes a transceiver 910, a memory 920, and a processor 930. The transceiver 910, the memory 920, and the processor 930 may operate according to a communication method as described above. However, the components of the UE or the base station are not limited thereto. For example, the UE or the base station may include more or fewer components than those described above. In addition, the processor 930, the transceiver 910, and the memory 920 may be implemented as a single chip. Also, the processor 930 may include at least one processor.

The transceiver 910 collectively refers to a receiver and a transmitter, and may transmit/receive a signal to/from a base station, a UE, or a network entity. The signal transmitted or received to or from the base station, the UE, or the network entity may include control information and data. The transceiver 910 may include an RF transmitter for up-converting and amplifying a frequency of a transmitted signal, and an RF receiver for amplifying low-noise and down-converting a frequency of a received signal. However, this is only an example of the transceiver 910 and components of the transceiver 910 are not limited to the RF transmitter and the RF receiver.

The transceiver 910 may receive and output, to the processor 930, a signal through a wireless channel, and transmit a signal output from the processor 930 through the wireless channel.

The memory 920 store a program and data required for operations of the UE or the base station. The memory 920 may store control information or data included in a signal obtained by the UE or base station. The memory 920 may be a storage medium, such as ROM, RAM, a hard disk, a CD-ROM, a DVD, or a combination of storage media.

The processor 930 may control a series of processes such that the UE or the base station operate as described above. For example, the transceiver 910 may receive a data signal including a control signal transmitted by the base station or the network entity, and the processor 930 may determine a result of receiving the control signal and the data signal transmitted by the base station or the network entity.

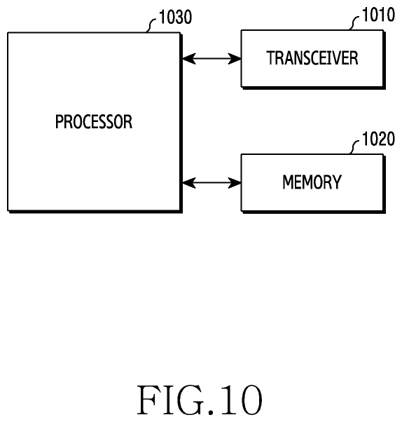

FIG. 10 illustrates a network entity according to an embodiment. For example, the network entity may include an MnS producer, an MnS Consumer, and/or a satellite.

Referring to FIG. 10, the network entity includes a transceiver 1010, a memory 1020, and a processor 1030. The transceiver 1010, the memory 1020, and the processor 1030 may operate according to a communication method of any network entity described above. However, the components of the network entity are not limited thereto. For example, the network entity may include more or fewer components than those described above. In addition, the processor 1030, the transceiver 1010, and the memory 1020 may be implemented as a single chip. Also, the processor 1030 may include at least one processor.

The transceiver 1010 collectively refers to a receiver and a transmitter, and may transmit/receive a signal to/from a UE, a base station, or other network entity. The signal transmitted or received to or from the UE, the base station, or the other network entity may include control information and data. The transceiver 1010 may include an RF transmitter for up-converting and amplifying a frequency of a transmitted signal, and an RF receiver for amplifying low-noise and down-converting a frequency of a received signal. However, this is only an example of the transceiver 1010, and components of the transceiver 1010 are not limited to the RF transmitter and the RF receiver.

The transceiver 1010 may receive and output, to the processor 1030, a signal through a wireless channel, and transmit a signal output from the processor 1030 through the wireless channel.

The memory 1020 may store a program and data required for operations of the network entity. The memory 1020 may store control information or data included in a signal obtained by the network entity. The memory 1020 may be a storage medium, such as ROM, RAM, a hard disk, a CD-ROM, a DVD, or a combination of storage media.

The processor 1030 may control a series of processes such that the network entity operates as described above. For example, the transceiver 1010 may receive a data signal including a control signal, and the processor 1030 may determine a result of receiving the control signal and the data signal.

Components according to example embodiments of the disclosure may be referenced by using modules or units. The modules or units may be implemented with various hardware devices, such as an integrated circuit, an ASIC, a FPGA, and a complex programmable logic device (CPLD), firmware driven in hardware devices, software such as an application, or a combination of hardware device and software. Also, the modules or units may include circuits implemented with semiconductor elements in an integrated circuit, or circuits enrolled as an intellectual property (IP).

A description of an example embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIGS. 6A, 6B, 7A, and 7B show certain events occurring in a certain order. In alternative embodiments, certain operations may be performed in a different order, modified, or removed. Moreover, operations may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments is intended to be illustrative, but not limiting, of the scope of the disclosure, which is set forth in the following claims.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope.

While the disclosure has been particularly shown and described with reference to certain embodiments thereof, it will be understood by those of ordinary skill in the art that various changes in form and details may be made therein without departing from the spirit and scope of the disclosure as defined by the appended claims and their equivalents.

What is claimed is:

1. A management service (MnS) producer in a wireless communication system, the MnS producer comprising:
a transceiver, and
a controller couple with the transceiver, and configured to:
receive, from an MnS consumer, a request for creating a managed object instance (MOI) of an access and mobility management function (AMF) information object class (IOC), wherein the AMF IOC includes a first attribute for a satellite coverage information, and
transmit, to the MnS consumer, a response of a creation of the MOI.

2. The MnS producer of claim 1, wherein a data type of the first attribute includes a second attribute for a new radio (NR) satellite radio access technology (RAT) type of an NR satellite access and a third attribute for location information of a satellite coverage.

3. The MnS producer of claim 2, wherein a data type of the third attribute includes a fourth attribute for a first time window for which the satellite coverage is available or a fifth attribute for a second time window for which the satellite coverage is unavailable.

4. The MnS producer of claim 2, wherein the NR satellite RAT type includes one of values of NR low earth orbit (LEO), NR medium earth orbit (MEO), NR geostationary equatorial orbit (GEO), or NR other satellite.

5. A management service (MnS) consumer in a wireless communication system, the MnS consumer comprising:
a transceiver, and
a controller couple with the transceiver, and configured to:
transmit, to an MnS producer, a request for creating a managed object instance (MOI) of an access and mobility management function (AMF) information object class (IOC), wherein the AMF IOC includes a first attribute for a satellite coverage information, and
receive, from the MnS producer, a response of a creation of the MOI.

6. The MnS consumer of claim 5, wherein a data type of the first attribute includes a second attribute for a new radio (NR) satellite radio access technology (RAT) type of an NR satellite access and a third attribute for location information of a satellite coverage.

7. The MnS consumer of claim 6, wherein a data type of the third attribute includes a fourth attribute for a first time window for which the satellite coverage is available or a fifth attribute for a second time window for which the satellite coverage is unavailable.

8. The MnS consumer of claim 6, wherein the NR satellite RAT type includes one of values of NR low earth orbit (LEO), NR medium earth orbit (MEO), NR geostationary equatorial orbit (GEO), or NR other satellite.

9. A method performed by a management service (MnS) producer in a wireless communication system, the method comprising:
receiving, from an MnS consumer, a request for creating a managed object instance (MOI) of an access and mobility management function (AMF) information object class (IOC), wherein the AMF IOC includes a first attribute for a satellite coverage information; and
transmitting, to the MnS consumer, a response of a creation of the MOI.

10. The method of claim 9, wherein a data type of the first attribute includes a second attribute for a new radio (NR) satellite radio access technology (RAT) type of an NR satellite access and a third attribute for location information of a satellite coverage.

11. The method of claim 10, wherein a data type of the third attribute includes a fourth attribute for a first time window for which the satellite coverage is available or a fifth attribute for a second time window for which the satellite coverage is unavailable.

12. The method of claim 10, wherein the NR satellite RAT type includes one of values of NR low earth orbit (LEO), NR medium earth orbit (MEO), NR geostationary equatorial orbit (GEO), or NR other satellite.

13. A method performed by a management service (MnS) consumer in a wireless communication system, the method comprising:
transmitting, to an MnS producer, a request for creating a managed object instance (MOI) of an access and mobility management function (AMF) information object class (IOC), wherein the AMF IOC includes a first attribute for a satellite coverage information; and
receiving, from the MnS producer, a response of a creation of the MOI.

14. The method of claim 13, wherein a data type of the first attribute includes a second attribute for a new radio (NR) satellite radio access technology (RAT) type of an NR satellite access and a third attribute for location information of a satellite coverage.

15. The method of claim 14, wherein a data type of the third attribute includes a fourth attribute for a first time window for which the satellite coverage is available or a fifth attribute for a second time window for which the satellite coverage is unavailable.

16. The method of claim 14, wherein the NR satellite RAT type includes one of values of NR low earth orbit (LEO), NR medium earth orbit (MEO), NR geostationary equatorial orbit (GEO), or NR other satellite.
